(19) United States
(12) Patent Application Publication
(10) Pub. No.: US 2010/0090458 A1
(43) Pub. Date: Apr. 15, 2010

(54) Multicoupling Device

(75) Inventors: Winfried Schulz, Neuhausen (DE); Hans-Jürgen Claus, Stuttgart (DE); Klaus Zoller, Stuttgart (DE); Viola Amiridis, Esslingen (DE); Hans-Walter Brenner, Stuttgart (DE); Martin Weiss, Goppingen (DE); Monika Scherer, Schallstadt/Mengen (DE)

Correspondence Address: Charles R Hoffmann;Hoffmann & Baron, 6900 Jericho Turnpike, Syosset, NY, 11791, US

(73) Assignee: Festo AG & Co., Esslingen (DE)

(21) Appl. No.: 12/224,747

(22) PCT Filed: Feb. 14, 2007
(86) PCT No.: PCT/EP2007/001266

§ 371 Date: Sep. 19, 2008

(30) Foreign Application Priority Data
Mar. 6, 2006 (DE) 10 2006 010 164.2

(51) Int. Cl. F16L 37/248

(52) U.S. Cl. 285/26

(57) ABSTRACT

A multiple coupling means for the production of a detachable connection between fluid lines for a fluid pressure medium, said fluid lines being associated with a fluid pressure producer being on the pressure source side and fluid lines associated with at least one fluid load and being on the load side, comprises a first coupling part (12), which has several first fluid ports (13) for the fluid lines on the source side, and a second coupling part (14), which has several fluid ports (15) for the fluid lines on the load side, the two coupling parts (12 and 14) being able to be shifted during a coupling operation by traveling toward each other in the direction of an installation axis (17) into a working position (18), in which a fluid passage through the two coupling parts (12 and 14) is formed and in which the two coupling parts (12 and 14) are secured by means of a holding means (22 and 29) to avoid uncoupling, and a manually operable slide element (19) is provided, which is able to be shifted in an actuation plane extending athwart the installation axis (17) between a coupling/uncoupling position (20) rendering possible coupling and uncoupling of the two coupling parts (12 and 14) and a securing position (21) associated with the working position (18) of the two coupling parts (12 and 14).

The invention relates to a multiple coupling means for the production of a detachable connection between fluid lines for a fluid pressure medium, said fluid lines being associated with a fluid pressure producer being on the pressure source side and fluid lines associated with at least one fluid load and being on the load side, comprising a first coupling part, which has several first fluid ports for the fluid lines on the source side, and a second coupling part, which has several fluid ports for the fluid lines on the load side, the two coupling parts being able to be shifted during a coupling operation with a movement toward each other in the direction of an installation axis into a working position, in which a fluid passage through the two coupling parts is formed and in which the two coupling parts are secured by means of a holding means to avoid uncoupling.

Such a multiple coupling means is disclosed in the German patent publication DE 1 923 186, in which a first coupling part on the source side is provided resembling a multipole electrical jack fitting into a second coupling part on the load side in the form of a corresponding socket. In order to avoid release or uncoupling of the two coupling parts, more particularly under fluid pressure, from each other a strip spring may be provided with a inwardly extending spur may be provided which during coupling snaps into a recess in the second coupling part provided for this purpose.

The coupling of fluid lines under pressure using a coupling means requires a substantial amount of physical effort, since the operation must be performed against fluid pressure. In the case of the multiple or multi-pole coupling the force applied is multiplied by the number of connected fluid lines. For example in the case of the above mentioned prior art it is necessary to insert the first coupling part prior art it is necessary to insert the first coupling part resembling a jack against the check valves held in the closed position against the fluid pressure and spring force. A coupling operation by hand is made difficult or even rendered impossible owing to the great force required.

One object of the invention is to provide a multiple coupling means of the type initially mentioned in the case of which the coupling operation may take place with a relatively small amount of force by hand.

This aim is achieved by a multiple coupling means with the features of the independent claim 1. Further developments of the invention are recited in the dependent claims.

The multiple coupling means in accordance with the invention is characterized in that between the two coupling parts at least one manually operable slide element is provided, which is able to be shifted in an actuation plane extending athwart the installation axis between a coupling/uncoupling position of the two coupling parts rendering possible coupling and uncoupling of the two coupling parts and a securing position associated with the working position of the two coupling parts.

Owing to the slide element able to be shifted in the plane of movement extending athwart the installation axis the coupling operation can be performed without any great manual effort. As a rule the flow direction of the fluid flowing through the coupling means runs parallel to the installation axis of the two coupling parts with the result that the coupling operation, in which the coupling parts are shifted toward one another in the direction of the installation axis is hindered by the fluid pressure. The actuation of the slide element however occurs with such a conduction of the flow athwart the flow direction of the fluid so that it is not necessary to work contrary to the fluid pressure. Preferably the slide element is firstly located in its coupling/uncoupling position, in which the two coupling parts can be coupled together, the passage of fluid being simultaneously prevented by the coupling part associated with the slide element. At the corresponding second coupling part the associated fluid lines may be either free of pressure or vented or may be secured by check valves so that movement toward each other of the coupling parts is not hindered by discharging fluid. Alternatively it is possible to assign a separate slide element to each coupling part, it being possible to link or couple the two slide elements together mechanically so that same can be shifted jointly between their respective coupling/uncoupling position and their respective end position. In the case of this modification there is a double acting obturation.

In a particularly preferred fashion the slide element and the holding means are so designed and so cooperate together that during motion of the slide element into its coupling/uncoupling position the passage of fluid through the two coupling parts is at least partially able to be shut off, the two coupling parts being simultaneously joined together undetachably prior to reaching the coupling/uncoupling position. Accordingly it is possible to partially or completely shut off the passage of fluid by means of the slide element without a so-called rebound occurring, in which the two coupling parts are violently forced apart by the fluid pressure obtaining at the slide element. In the case of the first modification mentioned above it is now necessary to vent the fluid lines upstream from one of the two coupling parts before the slide element gets to its coupling/uncoupling position. In the case of the above mentioned second modification double acting obturation is produced by the two slide elements so that the slide elements may in this case be readily shifted into their coupling/uncoupling position.

In the case of a further development of the invention the first and the second fluid ports are designed in the form of fluid ducts extending through the respective coupling part, the slide element having through openings in the securing position of the slide element are connected with the fluid ducts so that flow bridges are formed between the first and the second fluid ducts. Preferably the first and the second fluid ducts run essentially parallel to the installation axis between the top and bottom side of the respective coupling part, a respective first fluid duct in the first coupling part being, in the end position of the slide element, essentially flush with the associated through opening in the slide element and essentially flush with the associated second fluid duct in the second coupling part. The slide element may therefore act as a sort of baffle, the first and second fluid ducts, which essentially run flush to each other, being partially or completely obturated by changing the position of the through openings as related to the first and second fluid ducts.

In a particularly preferred fashion at least one slide element is designed in the form of a more particularly circular indexing disk, which is arranged between the two coupling parts and is able to be rotated in a rotary movement, with the installation axis as an axis of turning, between the coupling/uncoupling position and the securing position. The indexing disk is accordingly compactly accommodated between the two coupling parts. On turning the indexing disk therefore neither is there a movement together or apart of the coupling parts in an axial direction parallel to the installation axis nor a movement of the indexing disk out of the portion between the two coupling parts.

As an alternative it is possible for the slide element to be designed in the form of setting slide, which is able to be slid between the coupling/uncoupling position and the end position. For instance such a setting slide may have at least one row of holes with through openings, which in the securing position are aligned with the first and the second fluid ducts in the two coupling parts so that a fluid passage is formed between the coupling means.

As already mentioned the multiple coupling means possesses holding means to prevent the two coupling parts from uncoupling and to prevent the two coupling parts being suddenly separated by fluid pressure. As holding means it is possible to provide a projection, centered on the axis of rotation, on one of the coupling part or on the indexing disk, and a recess in the slide element or in one of the coupling parts, the projection and the recess being able to be to be plugged together in the coupling/uncoupling position of the indexing disk, while in another position, able to be reached by turning movement of the indexing disk, an undetachable connection is formed between the two coupling parts. The two coupling parts may consequently firstly be plugged together and then secured by a turning movement and accordingly a sort of plug and turn connection may be used.

In a particularly preferred manner the recess is has a keyhole-like form, the projection having a key-like cross section portion, which is adjoined in the plugging direction by a cylindrical turning portion, the recess being located in the plugged together state of the indexing disk and the associated coupling part in the cylindrical rotary portion. Accordingly rotation of the indexing disk in relation to the coupling part is possible. The cooperation of the keyhole-like recess and the key-like cross section portion and the cylindrical rotary portion may be like that of a bayonet joint.

In order to limit the turning movement of the indexing disk in relation to the coupling parts and to set the coupling/uncoupling position and the securing position of the indexing disk, a rotation limiting means may be provided. The rotation limiting means may comprise at least one slot-like elongated guide opening formed in one or both coupling parts and at least one guide pin fitting into the elongated guide opening in one of the coupling parts or in the indexing disk, the two ends of the elongated guide opening serving as abutments for the guide pin. Preferably several elongated guide openings are distributed over the periphery of the indexing disk.

In order to ensure that on turning the indexing disk into the coupling/uncoupling position and on the accompanying shutting off of the fluid passage, for its part the indexing disk is not suddenly pushed away by fluid pressure from the associated coupling part, a connection means may be provided to connect the indexing disk and the associated coupling part. Preferably in the case of the modification with only one indexing disk the latter is coupled with that coupling part, which does not have the projection belonging to the holding means.

The coupling means may have a cylindrical union sleeve formed on the indexing disk and sleeve socket formed on the coupling part, in which the union sleeve is able to turn, the union sleeve being joined by securing means in a detachable manner to the coupling part. This arrangement renders possible rotation of the indexing disk in relation to the setting slide as well while nevertheless being secured to it. As securing means it is possible for example to provide an annular groove in the union sleeve and a securing ring able to be inserted into the annular groove. As a securing ring a snap ring may for example be employed.

Preferred working examples of the invention are illustrated in the accompanying drawings and will be described in detail in the following.

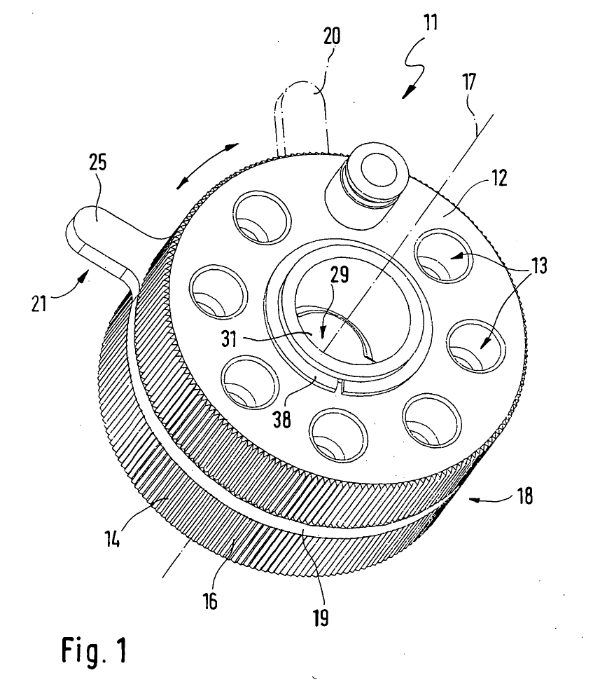

FIG. 1 shows a perspective elevation of a first working example of the multiple coupling means in accordance with the invention.

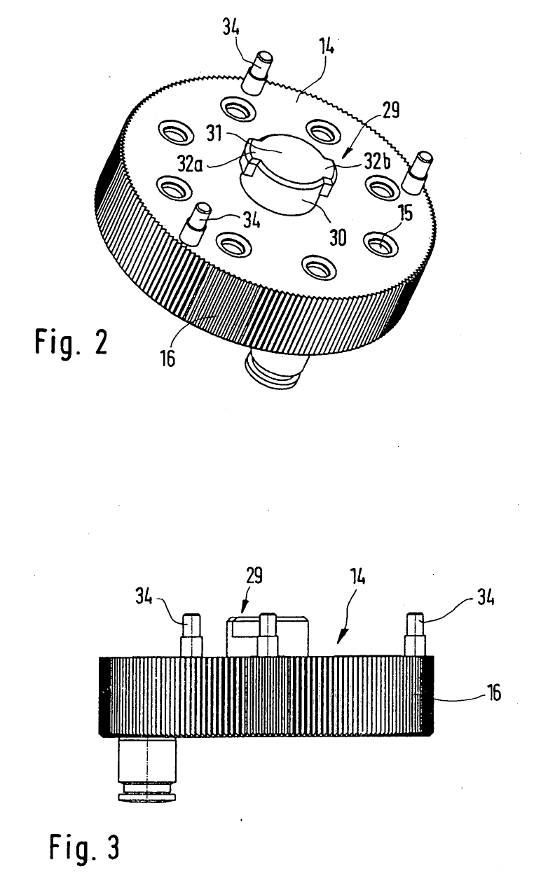

FIG. 2 is a perspective representation of the second coupling part in the coupling means of FIG. 1.

FIG. 3 shows the second coupling part as in FIG. 2 in a lateral view.

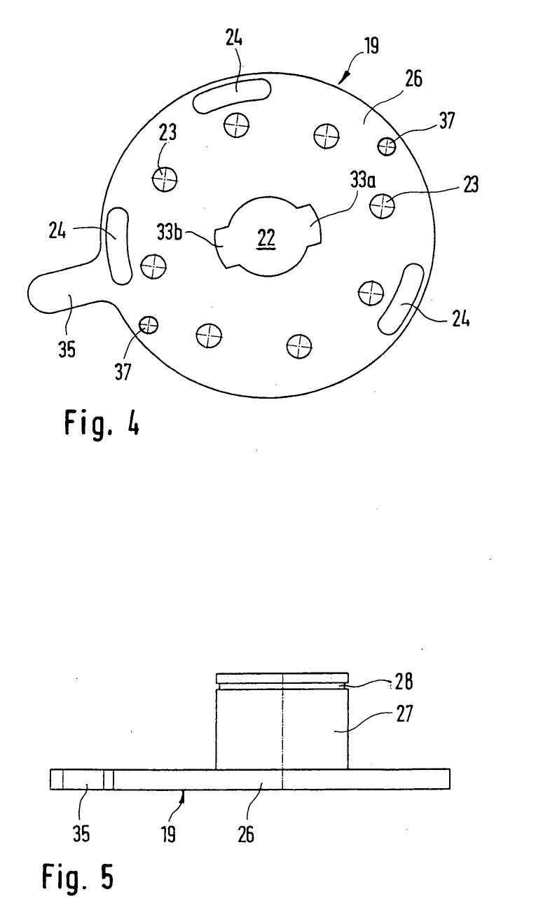

FIG. 4 is a plan view of the slide element in the form of a indexing disk in the coupling means of FIG. 1.

FIG. 5 shows the indexing disk of FIG. 4 from the side.

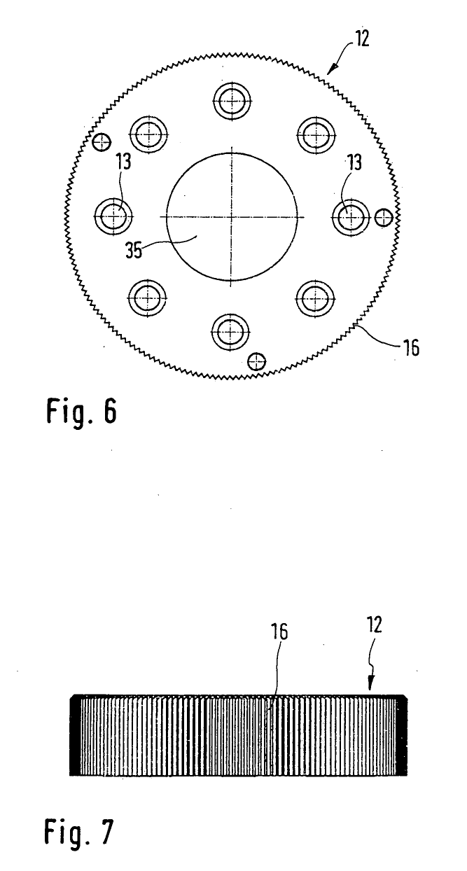

FIG. 6 is a plan view of the first coupling part in the coupling means of FIG. 1.

FIG. 7 shows the first coupling part as in FIG. 6 from the side.

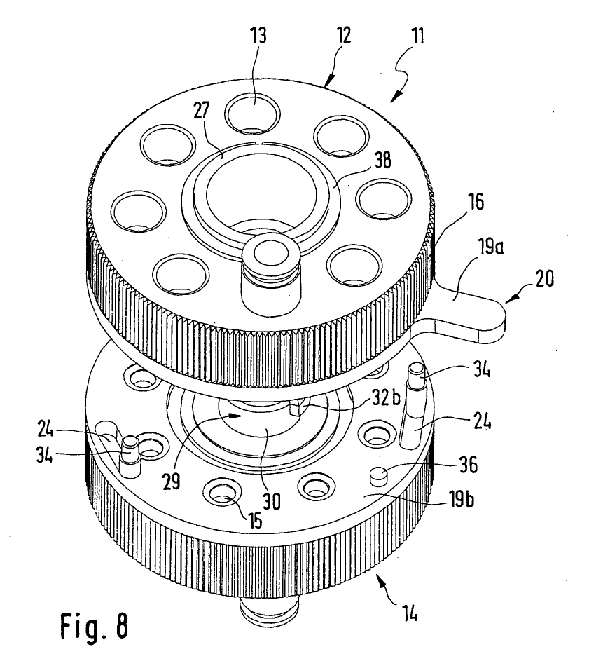

FIG. 8 is a perspective representation of a second working embodiment of the multiple coupling means in accordance with the invention, two slide elements in the form of indexing disks being provided.

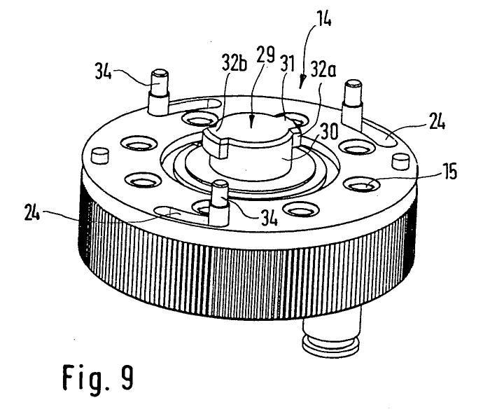

FIG. 9 is a perspective showing of the second coupling part together with the associated indexing disk in the coupling means of FIG. 8.

FIGS. 1 through 7 represent a first working three-dimensional of the multiple coupling means 11 in accordance with the invention, which could also be termed a multi-pole coupling. For the sake of simplicity the multiple coupling means is in the following referred to as the coupling means 11. Such coupling means 11 serve to provide a detachable connection between fluid lines (not illustrated) associated with a fluid pressure producer and on the pressure source side fluid lines (not illustrated) associated with at least one fluid load and on the load side. As a fluid pressure medium compressed air more particularly is concerned. As a fluid pressure producer an air compressor may more particularly be employed.

The coupling means 11 possesses a first coupling part 12 on the pressure source side, such part being in the following referred to as the first coupling part 12, which has several first fluid ports 13 for the connection of the fluid lines on the pressure producer or source side. Furthermore a second coupling part 14 on the load side is provided, which in the following will be referred to as the second coupling part 14, which has several second fluid ports 15 for the connection of the fluid lines which are on the load side.

The first working embodiment, illustrated in FIGS. 1 through 7 by way of example, of the coupling means 11 possesses a first coupling part 12 of cylindrical shape, which has several annularly arranged first fluid ports in the form of fluid ducts 13, more particularly with a cylindrical shape. The diameter of the first coupling part 12 is in this case larger than its height. The fluid ducts 13 extend right through the cylindrical first coupling part 12 from its top side to its bottom side. The peripheral face of the first coupling part is knurled at 16 so that it may be more readily grasped.

The second coupling part 14 also possesses a cylindrical configuration, more particularly with dimensions identical to those of the first coupling part 13 as regards the diameter and the height. Annularly arranged second fluid ports in the form of fluid ducts 15 are provided.

During the coupling operation the two coupling parts 12 and 14 are shifted together in the direction of an installation axis 17 into a working position 18, in which a passage for fluid is formed through the two coupling parts 12 and 14 and in which the two coupling parts 12 and 14 are held by holding means to prevent uncoupling. Coupling of fluid lines under pressure in the case of a multi-pole coupling requires a substantial physical effort. In order nevertheless to permit coupling by hand a manually operated slide element 19 is provided between the two coupling parts 12 and 14 and it may be shifted in an actuating plane extending athwart the installation axis 17 between a coupling/uncoupling position 20 (which renders possible coupling and uncoupling of the two coupling parts 12 and 14) and a securing position 21 associated with the working position 18 of the two coupling parts. Accordingly under fluid coupling does not occur parallel to the installation axis, i. e. against the flow direction, but in an installation plane athwart the actuating plane. The amount of force to be applied is accordingly substantially reduced.

In accordance with the first working example of the invention the slide element is in the form of a more particularly circular indexing disk 19, which can be termed a locking or obturating disk. As more particularly indicated in FIG. 1 the indexing disk 19 is located between the first and the second coupling parts 12 and 14. Preferably the diameter of the indexing disk 19 is the same as the diameter of the first and second coupling part 12 and 14. The indexing disk 19 is able to be turned in a rotary movement with the installation axis 17 as the axis of rotation between the coupling/uncoupling position 20 and the securing position 21.

As more especially indicated in FIG. 4 the indexing disk 19 has a central keyhole-like recess 22 which is a part of the holding means to be described in the following in detail. Furthermore on the indexing disk 19 there are annularly arranged and preferably circular through openings 23 which are able to be set in their securing position 21 flush with the first and the second fluid ducts 13 and 15 in the first and the second coupling part 12 and 14 with the result that a fluid passage is produced through the coupling means 11. Furthermore also near the disk's edge there are elongated guide openings 24, which are like slots. The elongated guide openings 24 are a part of a rotation limiting means 25 to be explained in detail in the following. In the present example (FIG. 4) there are three elongated guide openings distributed around the periphery of the indexing disk 19. In order to turn the indexing disk in relation to the coupling parts 12 and 14 same possesses a handle 25 which in the present case is represented as an outwardly extending spur connected integrally with the peripheral face of the indexing disk.

As shown in FIG. 5 the indexing disk 19 possesses a cylindrical union sleeve 27 arranged integrally on the circular base body 26 of the indexing disk 19, such sleeve being a component of the connection means, described in the following in more detail, for joining the indexing disk 19 with its associated coupling part 12. The union sleeve 27 is arranged at the center and is accordingly centered on the installation axis 17. The height of the union sleeve 27 is larger than the thickness of the indexing disk 19 and accordingly larger than the height of the associated coupling part 12 so that the top portion of the union sleeve 27 stands proud of the coupling part 12. On this top portion there is an annular groove 28 as a part of the securing means for connection of the indexing disk 19 and the associated coupling part 12.

FIGS. 2 and 3 illustrate the already mentioned second coupling part 14, that has the other part of the holding means, namely a projection which is centrally arranged and accordingly centered on the installation axis 17. The projection 29 possesses a cylindrical rotary portion 30 which at one end is connected integrally with the coupling part 14 and at the other is connected with a key-like cross section portion 31. The configuration of the key-like cross section portion 31 is adapted to the shape of the key-like recess 22 in the indexing disk 19. For this purpose the key-like cross section portion 31 has spurs 32a and 32b projecting outward from the peripheral face and diametrally opposite to each other, such spurs having a counterpart in the spur-like wells 33a and 33b in the key-like recess 22 in the indexing disk 19. When the spur-like wells 33a and 33b are flush and in alignment with the spurs 32a and 32b in the cross section portion 31 the indexing disk 19 and the coupling part 14 may be plugged together. Then the indexing disk 19 on such plugging together takes up a position in the turning portion 30 behind the cross section portion 31 with the result that turning of the indexing disk is possible in relation to the coupling part 14.

On the second coupling part 14 there is moreover the other portion of the rotation limiting means, namely the guide pins 34 which project from the top side of the second coupling part 14 upwardly and may fit into the associated elongated guide openings 24 in the indexing disk 19.

FIGS. 6 and 7 show the first coupling part 12, which is joined with the indexing disk 19 by way of the coupling means. For this purpose the first coupling part 12 has a centrally arranged cylindrical sleeve socket 35 wherein the union sleeve 27 is rotatably mounted. As shown in FIG. 1 the top portion of the union sleeve 27 stands proud of the top side of the first coupling part 12, the annular groove formed in the union sleeve 27 terminating essentially flush with the top side of the coupling part with the result that a securing ring 38, for example in the form of a snap ring, may hold the union sleeve 27 on the first coupling part 12.

During coupling with the first working example of the coupling means 11 depicted in FIGS. 1 through 7 there is firstly a situation in which no fluid may from leak second fluid ducts 15 on the coupling side of the second coupling part, something which would hinder the movement together of the two coupling parts 12 and 14. This is possible since the fluid lines connected with the second coupling part are vented or return flow of fluid is avoided by having check valves. The indexing disk 19 and the first coupling part are joined together via the coupling means, the indexing disk being in its coupling/uncoupling position 20 in which the first fluid ducts are shut off by the indexing disk. The indexing disk 19 in this case acts as a single acting obturating element. Therefore the fluid pressure obtaining at the first coupling part may be maintained. The next step is for the second coupling part 14 on the one hand and the indexing disk 19 together with the first coupling part 12 on the other hand to be so aligned that the spur-like wells 33a and 33b in the keyhole-like recess 22 in the indexing disk 19 are flush with the spurs 32a and 32b on the key-like cross section portion on the projection 29 on the second coupling part 14. In this aligned position the second coupling part 14 and the indexing disk 19 together with the first coupling part 12 may be plugged together. During such plugging together the indexing disk now shifts into the portion of the cylindrical rotatable portion 30 on the projection with the result that rotation of the indexing disk in relation to the two coupling parts 12 and 14 is possible. Simultaneously on plugging of the two coupling parts 12 and 14 the guide pins arranged on the second coupling part fit into the associated elongated guide openings 24 in the indexing disk 19. Then the ends of the elongated guide openings strike the guide pins so that rotation of the indexing disk is merely possible in a certain direction, namely in a direction toward the other end of the elongated guide openings 24. The indexing disk 19 is therefore in its coupling/uncoupling position 20 and is now twisted by using the handle 25 more particularly counterclockwise in relation to the two coupling parts 12 and 14. Then the spur-like wells 33a and 33b in the key-like recess 22 are at the indexing disk 19 and the spurs 32a and 32b on the cross section portion of the projection are no longer flush, i. e. the spurs 32a and 32b on the key-like cross section portion prevent any pulling off of the indexing disk together with the first coupling part 12 opposite to the plugging in direction from the second coupling part 14. The two coupling parts 12 and 14 are accordingly secured. By further rotation of the indexing disk 19 counterclockwise finally now the through openings 23 are aligned to the first and the second fluid ducts 13 and 14 so that a fluid passage is created through the coupling means 11. This position is more especially set by the other end of the respective elongated guide openings, which then together with the associated guide pins 34 constitutes a rotation limiting abutment.

The uncoupling operation takes place in the reverse order. I. e. firstly the indexing disk 19is in its securing position 21, in which the through openings 19 of the indexing disk 19 are aligned to be flush with the first and with the second fluid ducts 13 and 15. By turning the indexing disk 19, more especially clockwise, the first and the second fluid ducts are shut off. In this case there is a so-called rebound or backlash effect, that is to say the fluid pressure will initially be present on either side of the indexing disk 19 with the result that the two coupling parts 12 and 14 will tend to move apart. Such an effect is however hindered by the holding means, that is to say by the key-like cross section 33 on the second coupling part and the keyhole-like recess 22 in the indexing disk, since the spur-like wells 33a and 33b and the spurs 32a and 32b are not yet flush with one another and accordingly separation of the two coupling parts 12 and 14 is not yet possible. The next step necessary is therefore to ensure that there is no more fluid pressure acting on the second coupling part 14. It is only then that the indexing disk can be turned on farther into its coupling/uncoupling position so that the second coupling part may be separated from the indexing disk 19 together with the first coupling part 12.

FIGS. 8 and 9 show a second working embodiment of the coupling means 11 in accordance with the invention, which differs from the first working example to the extent that two indexing disks 19a and 19b are provided, of which one a first indexing disk 19a is joined in a manner identical to the first working example with the first coupling part 12, whereas the second indexing disk 19b is associated with the second coupling part 14.

The second indexing disk 19b, unlike the first indexing disk, has no handle, since it is mechanically joined to the first indexing disk 19a, for example by means of connecting pins 36, which extend from the top side of the second indexing disk 19b upward and fit into recesses 37, provided for this purpose in the first indexing disk 19a (FIG. 4). Furthermore the second indexing disk 19a has no union sleeve, but it is however secured in a rotatable fashion on the second coupling part 14 and accordingly held against detachment, more especially when fluid pressure obtains at the second coupling part.

The coupling operation with the second working example differs from the coupling operation with the first working example in as far as in this case there is a double sided obturation by the two indexing disks 19a and 19b so that both at the first coupling part 12 and also at the second coupling part 14 coupling takes place in an identical manner to that with the first example.

In the case of the uncoupling operation owing to the double sided obturation it is not necessary, prior to turning the indexing disk in the coupling/uncoupling position, to “switch” one of the two coupling parts to be pressureless and in fact in this case turning into the coupling/uncoupling position 20 is quite readily possible.

1. A multiple coupling means for the production of a detachable connection between fluid lines for a fluid pressure medium, said fluid lines being associated with a fluid pressure producer being on the pressure source side and fluid lines associated with at least one fluid load and being on the load side, comprising a first coupling part, which has several first fluid ports for the fluid lines on the source side, and a second coupling part, which has several fluid ports for the fluid lines on the load side, the two coupling parts being able to be shifted during a coupling operation with a movement toward each other in the direction of an installation axis into a working position, in which a fluid passage through the two coupling parts is formed and in which the two coupling parts are secured by means of a holding means to avoid uncoupling, wherein at least one manually operable slide element is provided between the two coupling parts, said slide element being able to be shifted in an actuation plane extending athwart the installation axis between a coupling/uncoupling position rendering possible coupling and uncoupling of the two coupling parts and a securing position associated with the working position (18) of the two coupling parts.

2. The coupling means in accordance with claim 1, wherein the slide element and the holding means are so designed and so cooperate that on the movement of the slide element into its coupling/uncoupling position the fluid passage through the two coupling parts may be at least partly shut off and simultaneously the two coupling parts are undetachably joined together before reaching the coupling/uncoupling position of the slide element.

3. The coupling means in accordance with claim 1, wherein the first and the second fluid ports of the first and the second coupling part are formed as fluid ducts extending through the respective coupling part and wherein the slide element comprises passage openings which are so connected together in the securing position of the slide element with the fluid ducts that flow bridges are formed between the first and the second fluid ducts.

4. The coupling means in accordance with claim 3, wherein the first and the second fluid ducts run essentially in parallelism to the installation axis between the top and bottom side of the respective coupling part, and in the securing position of the slide element a respective first fluid duct in the first coupling part is aligned to be essentially flush with the associated passage opening in the slide element and essentially flush with the associated second fluid duct in the second coupling part.

5. The coupling means in accordance with claim 1, wherein two mechanically linked slide elements are provided, of which a first slide element is associated with the first coupling part and a second slide element is associated with the second coupling part and the two slide elements are movable jointly between their respective coupling/uncoupling position and their respective securing position.

6. The coupling means in accordance with claim 1, wherein the at least one slide element is made in the form of a circular indexing disk, which is arranged between the two coupling parts and is able to be rotated in a rotary movement with the installation axis as the axis of rotation between the coupling/uncoupling position and the securing position.

7. The coupling means in accordance with claim 6, wherein as holding means a projection is provided centered on the axis of rotation on either of the coupling parts or on the indexing disk and a recess is provided in the indexing disk or on either of the coupling parts and the projection and the recess are able to be plugged together in the coupling/uncoupling position of the indexing disk, whereas in another position able to be reached in a rotary movement of the indexing disk an undetachable connection is produced between the two coupling parts.

8. The coupling means in accordance with claim 7, wherein the recess is in a form of a keyhole and the projection has a cross section portion corresponding to it, which is adjoined by a cylindrical rotary portion in the plugging direction, and the recess in the plugged together condition of the indexing disk and the coupling part is located at the cylindrical rotary portion.

9. The coupling means in accordance with claim 6, wherein a rotation limiting means is provided for limitation of the rotary motion of the indexing disk in relation to the coupling parts and for setting the coupling/uncoupling position and of the securing position of the indexing disk.

10. The coupling means in accordance with claim 9, wherein the rotation limiting means comprises at least one slot-like elongated guide opening formed on the indexing disk or on one of the two coupling parts and at least one guide pin fitting into the elongated guide opening and formed on one of the two coupling parts or on the indexing disk and the two ends of the elongated guide opening serve as abutments for the guide pin.

11. The coupling means in accordance with claim 6, wherein a connecting means is provided for connecting the indexing disk with the associated coupling part.

12. The coupling means in accordance with claim 11, wherein the connecting means comprises a cylindrical union sleeve formed on the indexing disk and a cylindrical sleeve socket formed on the associated coupling parts, in which the union sleeve is rotatably mounted, and the union sleeve is secured by securing means on the coupling part.

13. The coupling means in accordance with claim 12, wherein as the securing means, an annular groove in the union sleeve and a securing ring able to be lodged in the annular groove are provided.

14. The coupling means in accordance with claim 2, wherein the first and the second fluid ports of the first and the second coupling part are formed as fluid ducts extending through the respective coupling part, and wherein the slide element comprises passage openings which are so connected together in the securing position of the slide element with the fluid ducts that flow bridges are formed between the first and the second fluid ducts.

15. The coupling means in accordance with claim 14, wherein the first and the second fluid ducts run essentially in parallelism to the installation axis between the top and bottom side of the respective coupling part, and in the securing position of the slide element a respective first fluid duct in the first coupling part is aligned to be essentially flush with the associated passage opening in the slide element and essentially flush with the associated second fluid duct in the second coupling part.

16. The coupling means in accordance with claim 2, wherein two mechanically linked slide elements are provided, of which a first slide element is associated with the first coupling part and a second slide element is associated with the second coupling part and the two slide elements are movable jointly between their respective coupling/uncoupling position and their respective securing position.

17. The coupling means in accordance with claim 3, wherein two mechanically linked slide elements are provided, of which a first slide element is associated with the first coupling part and a second slide element is associated with the second coupling part and the two slide elements are movable jointly between their respective coupling/uncoupling position and their respective securing position.

18. The coupling means in accordance with claim 4, wherein two mechanically linked slide elements are provided, of which a first slide element is associated with the first coupling part and a second slide element is associated with the second coupling part and the two slide elements are movable jointly between their respective coupling/uncoupling position and their respective securing position.

19. The coupling means in accordance with claim 2, wherein the at least one slide element is made in the form of a circular indexing disk, which is arranged between the two coupling parts and is able to be rotated in a rotary movement with the installation axis as the axis of rotation between the coupling/uncoupling position and the securing position.

20. The coupling means in accordance with claim 3, wherein the at least one slide element is made in the form of a circular indexing disk, which is arranged between the two coupling parts and is able to be rotated in a rotary movement with the installation axis as the axis of rotation between the coupling/uncoupling position and the securing position.
